(19) United States
(12) Patent Application Publication
(10) Pub. No.: US 2010/0215816 A1
(43) Pub. Date: Aug. 26, 2010

(54) Antimicrobial Composition And Its Use In Ready-To-Drink Beverages

(76) Inventors: Zuoxing Zheng, Palatine, IL (US); Charles Arthur Kennett, Brookfield, IL (US); Karl Ragnarsson, Chester, NY (US); Jeffrey Semanchek, Ramsey, NJ (US)

Correspondence Address: FITCH EVEN TABIN & FLANNERY, 120 SOUTH LASALLE STREET, SUITE 1600, CHICAGO, IL, 60603-3406, US

(21) Appl. No.: 12/532,578

(22) PCT Filed: Mar. 28, 2008
(86) PCT No.: PCT/US08/58690

§ 371 Date: Mar. 5, 2010

(30) Foreign Application Priority Data
Mar. 28, 2007 (US) 11692496

(51) Int. Cl. A23L 3/3508; A01N 37/02; A01P 1/00; A23L 2/42

(52) U.S. Cl. 426/271; 514/558; 426/532

(57) ABSTRACT

An antimicrobial composition for food applications includes a chelating agent and a lauric acid derivative. The antimicrobial composition optionally includes one or more carboxylic acid derivatives. The chelating agent, the lauric acid derivative, and if present, one or more carboxylic acid derivatives are collectively present in an amount that is less that a taste threshold.

### CROSS-REFERENCE To RELATED APPLICATIONS

This application is a continuation-in part of U.S. patent application Ser. No. 11/692,496, filed Mar. 28, 2007, which is hereby incorporated by reference in its entirety.

### FIELD OF THE INVENTION

In at least one aspect, the present invention generally relates to antimicrobial compositions for use in food products, especially in ready-to-drink beverages, and more especially in cold processed ready-to-drink beverages.

### BACKGROUND

Spoilage resistance is desirable in all food products. In general, improvements in the spoilage characteristics of food products lead to retention of desirable color, flavor and nutrients with minimal formation of undesirable compounds. Economic benefits of reduced spoilage include cost reduction related to capital, energy and packaging material savings, and a longer shelf life.

Ready-to-drink (“RTD”) beverages are a class of food products in which spoilage reduction is desirable. Effective inhibition of all common spoilage organisms including vegetative gram positive and gram negative bacteria, bacterial spores, yeasts and molds in RTD beverages at ambient temperature is a challenge for the beverage industry. Currently, an effective ingredient solution for spoilage does not exist for cold fill juice-containing beverages. The most commonly used preservation method for such beverages is ultra high temperature treatment of the beverage and hot fill packaging. Both hot processing and hot filling of ready-to-drink beverages result in the loss of desirable flavor and color. Moreover, these processes typically require increased capital investment as well as additional operating and packaging material costs.

Cold fill processing of beverages is desirable as an alternative to the hot fill processes. However, cold fill processing of highly acidic, ready-to-drink beverages (especially juice-containing beverages) is often accompanied with a high risk of contamination by a variety of spoilage organisms—bacteria, yeasts and molds. To counter these undesirable microbes, preservatives are typically added to the beverages to extend shelf life. Currently, preservative solutions that prevent the growth of all these spoilage organisms in beverages at acceptable concentration levels do not exist.

Accordingly, there is a need for improved spoilage reducing compositions to be included in food products, and in particular, cold processed ready-to-drink beverages such that sufficient antimicrobial protection can be obtained without significantly impairing the organoleptic properties, and in particular the taste properties.

### SUMMARY OF THE INVENTION

The present invention solves one or more problems of the prior art by providing in at least one embodiment an antimicrobial composition for use in a food product. The antimicrobial composition of this embodiment includes a chelating agent, a lauric acid derivative, and at least two carboxylic acid derivatives. Advantageously, the chelating agent, the lauric acid derivative, and the at least two carboxylic acid derivatives are present in the ready-to-drink beverage in amounts that do not negatively impact the organoleptic properties but which still provides an acceptable taste. The antimicrobial compositions or cocktails of the present embodiment can be incorporated into cold processed RTD beverages, thus avoiding the heat-treating and/or hot filling methods typically used to eliminate spoilage bacteria, molds, and yeasts. Therefore, the ability of the present invention to use cold processing and cold filling techniques is highly desirable by the beverage industry to circumvent the loss of flavor and color, and increase expense of the hot processes of the prior art.

This invention is especially adapted to prepare liquid or pourable type food products. Thus, this invention can be used for liquid or pourable food products such as beverages (including concentrates and ready-to-drink types), syrups, dressings, condiments, liquids used to package fruits, vegetables, and the like, as well as similar food products. It is especially useful in preparing ready-to-drink beverages, including cold processed ready-to-drink beverages.

In another embodiment of the present invention, an antimicrobial composition for use in RTD beverages is provided. The antimicrobial compositions of the present invention can be added to the RTD beverage or the components of the antimicrobial compositions can be added separately, or in any combination thereof to the RTD beverage. Characteristically, the various components are collectively present in an amount less than their taste threshold. When the antimicrobial cocktail of the present embodiment is incorporated into RTD beverages, the resulting product is not required to be heat treated or hot filled as is typically used to eliminate spoilage bacteria, molds, and yeasts in conventional RTD beverages.

### DETAILED DESCRIPTION

Reference will now be made in detail to presently preferred compositions, embodiments and methods of the present invention, including the best mode of practicing the invention presently known to the inventors. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary so long as the desired stability and taste profiles are obtained. Furthermore, the terminology used herein is used only for the purpose of describing particular embodiments of the present invention and is not intended to be limiting in any way. Although the present invention may be used to prepare both hot processed and cold processed RTD beverages, it is especially useful in preparing cold processed RTD beverages.

It must also be noted that, as used in the specification and the appended claims, the singular form “a”, “an”, and “the” can also comprise plural referents unless the context clearly indicates otherwise. For example, reference to a component in the singular is intended to comprise one or more of the components.

Throughout this application, where publications are referenced, the disclosures of these publications in their entireties are hereby incorporated by reference into this application to more fully describe the state of the art to which this invention pertains.

An antimicrobial composition for use in a RTD beverage, and especially in a cold processed RTD beverage is provided. The antimicrobial composition of this embodiment includes a chelating agent, a lauric acid derivative, and at least two carboxylic acid derivatives in amounts sufficient to obtain the desired microbiological stability while maintaining the desirable organoleptic properties, especially with regard to taste, of the RTD beverage. Advantageously, the components of the antimicrobial composition (i.e., the chelating agent, the lauric acid derivative, and the at least two carboxylic acid derivatives) are present in amounts less than either their individual or collective taste thresholds. The antimicrobial compositions of the present embodiment inhibit the growth of a wide range of cold processes and cold fill related spoilage organisms in beverages. Accordingly, the antimicrobial compositions enable the utilization of cold processing and/or cold fill for many RTD beverages including juice-containing drinks. Moreover, the antimicrobial compositions of the present embodiment effectively inhibit the growth of spoilage organisms in such beverages or drinks.

In one refinement of the present embodiment, the chelating agent, the lauric acid derivative, and the at least two carboxylic acid derivatives are individually or collectively present in the RTD beverages in amounts. Typically, such components are collectively less than about 2200 ppm, preferably less than about 1000 ppm, and more preferably less than about 500 ppm such that they do not significantly impact the taste of the resulting RTD beverages but still provide sufficient antimicrobial protection. Typically, the chelating agent is present in the RTD beverage in an amount of about 10 to about 100 ppm; the lauric acid derivative is present in the RTD beverage in an amount of about 20 to about 100 ppm; and at least two carboxylic acid derivatives (e.g., sorbate and benzoate) being at a collective amount of about 200 to about 2000 ppm, and preferably individually at about 100 to about 1000 ppm, in the RTD beverage.

The antimicrobial composition of the present invention includes a lauric acid derivative. While any suitable lauric acid derivative may be used, particularly useful lauric acid derivatives comprise ethyl-N-dodecanoyl-L-arginate and/or derivatives thereof. Preferably ethyl-N-dodecanoyl-L-arginate is used and is present in the RTD beverage in an amount from about 20 to about 100 ppm, and even more preferably in an amount of about 25 to about 35 ppm.

The antimicrobial composition of the present invention also includes a chelating agent. While any suitable chelating agent can be used, ethylenediaminetetraacetic acid (EDTA) and/or derivatives thereof are especially preferred. Preferably EDTA is used and is present in the RTD beverage in an amount from about 10 to about 100 ppm, and even more preferably in an amount of about 20 to about 40 ppm.

As set forth above, the antimicrobial composition also includes at least two carboxylic acid derivatives. Virtually, any carboxylic acid derivative compatible with human consumption may be used. Carboxylic acid salts are particularly useful. In such salts, common counter ions include potassium and sodium. Preferred carboxylic acid derivatives include, but are not limited to, sorbates and benzoates. Preferably the at least two carboxylic acid include a sorbate and a benzoate. Specific examples of sorbates include potassium sorbate and sodium sorbate as well as mixtures thereof. Similarly, specific examples of benzoates include potassium benzoate and sodium benzoate as well as mixtures thereof. Preferably, the RTD beverage contains about 100 to about 1000 ppm of the sorbate and about 100 to about 1000 ppm of the benzoate. Even more preferably, the RTD beverage contains about 150 to about 500 ppm of the sorbate and about 150 to about 500 ppm of the benzoate. Preferably the sorbate is potassium sorbate and the benzoate is sodium benzoate.

Of course, if the antimicrobial composition is prepared separately the amounts the individual components in the separate composition can be higher than the amounts just given. The amount of the separate antimicrobial composition added to the RTD beverage can be adjusted to obtain the desired levels in the resulting RTD beverage. And whether added as a separate antimicrobial composition (e.g., aqueous based solution) or as separate components, the levels of the components in the RTD beverage should be ay levels sufficient to provide the desired microbiological stability without significantly impacting the taste profile of the RTD beverage.

In another embodiment of the present invention, a beverage including the antimicrobial compositions set forth above are provided. The beverage of this embodiment includes a food component and the antimicrobial compositions. Moreover, the beverages used herein can be cold processed or cold filled RTD beverages. In one refinement, the beverage compositions of this embodiment include a juice-containing component and the antimicrobial composition.

In yet another embodiment of the present invention, a method of forming a microbial resistant beverage is provided. The microbial resistant beverage of this embodiment is formed by adding the antimicrobial compositions (either as a separate composition or as individual components) set forth above to a base beverage composition. In the present context, “base beverage composition” means any ready-to-drink beverage composition not containing the antimicrobial compositions of the embodiment of the present invention. In a specific variation, the antimicrobial composition comprises a lauric acid derivative, a chelating agent, and one or more carboxylic acid derivatives. In a refinement of the present embodiment, one or more of the components of the antimicrobial composition are combined together before being added to a base beverage composition.

In another refinement of the present embodiment, each component of the antimicrobial composition is independently added to a base beverage composition. Advantageously, the antimicrobial compositions of the present invention are sufficiently effective to allow the elimination of heat processing during beverage production thereby allowing cold process and cold fill. Of course, if desired, hot processing of beverage formed in the present embodiment may also be utilized.

As shown in the examples below, the effective amounts of the various components from both microbiological and organoleptic standpoints can vary with the specific beverage and/or the process conditions used. The lower limit for the various components of the antimicrobial composition in a specific beverage and manufacturing process can easily be determined by one of ordinary skill in the art using routine experimentation relative to microbiological stability. Likewise, the upper limits for the various components of the antimicrobial composition in a specific beverage and manufacturing process can easily be determined by one of ordinary skill in the art using routine experimentation relative to the organoleptic properties. As noted throughout, the levels of the various components should be high enough to insure the desired microbiological stability while, at the same time, low enough so as not to significantly affect the organoleptic properties in a negative manner. For a given RTD beverage and manufacturing methods, the levels of the various components may even be outside the ranges specified above so long as the levels are high enough to insure the desired microbiological stability while, at the same time, low enough so as not to significantly affect the organoleptic properties in a negative manner.

The following examples illustrate the various embodiments of the present invention. Those skilled in the art will recognize many variations that are within the spirit of the present invention and scope of the claims.

The following examples demonstrate the effective prevention of a variety of spoilage issues caused by bacteria, yeast and mold, with a combination of lauric arginate and traditional preservatives at concentrations below acceptable taste thresholds. In these examples, a number of different combinations that include a cationic compound—lauric arginate (N-a-lauryl-L-arginine ethyl ester monohydrochloride (“LAE”) and the preservatives—potassium sorbate, sodium benzoate and EDTA were investigated against a number of selected spoilage bacteria, yeasts and molds commonly found in ready-to-drink beverages. The selected organisms used in microbial challenge studies and their preparation method, inoculation level, challenge conditions as well as the criteria for pass or fail are listed in Table 1. The selected organisms were derived from microorganisms known to have cause spoilage in beverages. However, not all organisms were used in every situation. Some organisms were used for juice containing or non-juice containing products or for processes utilizing a heat step or cold process/cold fill products. Similarly, inoculum levels were also influenced by use of raw materials (e.g., presence of juice) and/or utilization of heat in the process.

TABLE 1
Spoilage organisms used in microbiological challenge studies

| | Cultivation | Number of | Storage of | Inoculum | Storage | Pass |
|---|---|---|---|---|---|---|
| Organism | medium | transfers | inoculum | level | temp. | criteria |
| BACTERIA | | | | | | |
| Alicyclobacillus | OSA agar, 3-5 | 1-2 | Sterile | Low-High | 25-30° C. | No growth; |
| acidoterrestris (VF | days at 45° C. | | Phosphate | 10¹-10⁴ cfu/ml | | no off odor |
| strain) | | | buffer at | | | or off |
| | | | 4° C. | | | flavor |
| Alicyclobacillus | OSA agar, 3-5 | 1-2 | Sterile | Low-High | 25-30° C. | No growth; |
| acidoterrestris (Sport | days at 45° C. | | Phosphate | 10¹-10⁴ cfu/ml | | no off odor |
| strain) | | | buffer at | | | or off |
| | | | 4° C. | | | flavor |
| Gluconobacter | Acidified (pH | 1-2 | Sterile | Low-High | 25-30° C. | No growth; |
| oxydans | 3.5) MEA, 3-5 | | Phosphate | 10¹-10⁴ cfu/ml | | no off odor |
| | days, at 25° C. | | buffer at | | | or off |
| | | | 4° C. | | | flavor |
| Gluconoacetobacter | Acidified (pH | 1-2 | Sterile | Low-High | 25-30° C. | No growth; |
| liquifaciens | 3.5) MEA, 3-5 | | Phosphate | 10¹-10⁴ cfu/ml | | no off odor |
| | days, at 25° C. | | buffer at | | | or off |
| | | | 4° C. | | | flavor |
| Gluconoacetobacter | Acidified (pH | 1-2 | Sterile | Low-High | 25-30° C. | No growth; |
| diazotrophicus | 3.5) MEA, 3-5 | | Phosphate | 10¹-10⁴ cfu/ml | | no off odor |
| | days, at 25° C. | | buffer at | | | or off |
| | | | 4° C. | | | flavor |
| Acetobacter tropicalis | Acidified (pH | 1-2 | Sterile | Low-High | 25-30° C. | No growth; |
| | 3.5) MEA, 3-5 | | Phosphate | 10¹-10⁴ cfu/ml | | no off odor |
| | days, at 25° C. | | buffer at | | | or off |
| | | | 4° C. | | | flavor |
| Acetobacter | Acidified (pH | 1-2 | Sterile | Low-High | 25-30° C. | No growth; |
| calcoaceticus | 3.5) MEA, 3-5 | | Phosphate | 10¹-10⁴ cfu/ml | | no off odor |
| | days, at 25° C. | | buffer at | | | or off |
| | | | 4° C. | | | flavor |
| YEAST | | | | | | |
| Candida lypolytica | Acidified (pH | 1-2 | Sterile | Low-High | 25-30° C. | No growth; |
| | 3.5) PDA, 3-5 | | Phosphate | 10¹-10⁴ cfu/ml | | no off odor |
| | days, at 25° C. | | buffer at | | | or off |
| | | | 4° C. | | | flavor |
| Saccharomyces | Acidified (pH | 1-2 | Sterile | Low-High | 25-30° C. | No growth; |
| cerevisiae | 3.5) PDA, 3-5 | | Phosphate | 10¹-10⁴ cfu/ml | | no off odor |
| | days, at 25° C. | | buffer at | | | or off |
| | | | 4° C. | | | flavor |
| MOLD | | | | | | |
| Aspergillus niger | Acidified (pH | 1-2 | Sterile | Low-High | 25-30° C. | No growth; |
| | 3.5) PDA, 3-5 | | Phosphate | 10¹-10⁴ cfu/ml | | no off odor |
| | days, at 25° C. | | buffer at | | | or off |
| | | | 4° C. | | | flavor |
| Penicillium | Acidified (pH | 1-2 | Sterile | Low-High | 25-30° C. | No growth; |
| spinulosum | 3.5) PDA, 3-5 | | Phosphate | 10¹-10⁴ cfu/ml | | no off odor |
| | days, at 25° C. | | buffer at | | | or off |
| | | | 4° C. | | | flavor |

Unless otherwise indicated, all results of challenge studies are reported as Pass or Fail as described in Table 1. For microbial growth, in general, no detectable live cells present or less than 1 log of cell increase was considered as no growth while more than 1 log of cell increase is considered as a positive growth. “Pass” means there was no growth of any of the challenged organisms and no development of off-favor/odor during at least 4 months storage at ambient temperatures as described in Table 1. “Fail” means there was positive growth of at least one of the challenged organisms and/or the development of off-flavor/odor within the first four months of storage at ambient temperatures.

Example 1: A fruit juice-containing RTD beverage. A commercial fruit punch beverage was purchased from a local grocery store. It contained 10% mixed fruit juices with a pH of 3.5 and no preservatives. The main ingredients in the beverage included water, high fructose corn syrup, pear and grape juice concentrates, citric acid, water extracted orange and pineapple juice concentrates and natural flavors. This product represented a group of fruit punch and juice blended ready-to-drink beverages. The original beverage was used as control, and samples with added antimicrobials in a number of combinations were used as treatments. The spoilage bacteria, yeast and mold cocktails listed in Table 1 were used in this challenge study. The results of microbial challenge study are summarized in Table 2.

TABLE 2
Microbial challenge study for the fruit punch beverage

| | Lauric | | Na- | | |
|---|---|---|---|---|---|
| Treatment | Arginate | K-sorbate | benzoate | EDTA | Result |
| Test 1 | 0 | 0 | 0 | 0 | Fail (<8 days) |
| Test 2 | 30 ppm | 0 | 0 | 0 | Fail (<8 days) |
| Test 3 | 50 ppm | 0 | 0 | 0 | Fail (<7 days) |
| Test 4 | 100 ppm | 0 | 0 | 0 | Fail (<9 days) |
| Test 5 | 0 | 300 ppm | 300 ppm | 30 ppm | Fail (<13 days) |
| Test 6 | 30 ppm | 300 ppm | 0 | 0 | Fail (<8 days) |
| Test 7 | 30 ppm | 200 ppm | 200 ppm | 30 | Fail (<9 days) |
| Inventive | 30 ppm | 300 ppm | 300 ppm | 30 ppm | Pass |
| | | | | | (>8 months) |

These results suggest that, among all tested variables, only the inventive composition (i.e., the combination of lauric arginate, sorbate, benzoate and EDTA) passed the comprehensive microbial challenge study in a juice-containing RTD beverage.

Example 2: A fruit punch flavored sport drink. A fruit punch flavored sport drink was purchased from a local grocery store. This beverage contained fruit flavors while having 0% fruit juices and preservatives. The pH of this beverage was 3.5. The main ingredients in this beverage included water, high fructose corn syrup, sugar, citric acid, sodium citrate, potassium citrate and natural flavors. This product represents a group of fruit punch flavored ready-to-drink sport drinks. The original beverage was used as control, and samples with added antimicrobials in a number of combinations were used as treatments. The spoilage bacteria, yeast and mold cocktails listed in Table 1 were used in this challenge study. The results of microbial challenge study are summarized in Table 3.

TABLE 3
Microbial challenge study for the fruit punch flavored sport drink

| | Lauric | | Na- | | |
|---|---|---|---|---|---|
| Treatment | Arginate | K-sorbate | benzoate | EDTA | Result |
| Test 1 | 0 | 0 | 0 | 0 | Fail (<8 days) |
| Test 2 | 30 ppm | 0 | 0 | 0 | Fail (<8 days) |
| Test 3 | 50 ppm | 0 | 0 | 0 | Fail (<7 days) |
| Test 4 | 0 | 300 ppm | 300 ppm | 30 ppm | Fail (<13 days) |
| Test 5 | 30 ppm | 300 ppm | 0 | 0 | Fail (<8 days) |
| Test 6 | 30 ppm | 200 ppm | 200 ppm | 30 | Fail (<1 month) |
| Inventive | 30 ppm | 300 ppm | 300 ppm | 30 ppm | Pass |
| | | | | | (>8 months) |

These results obtained in a non-juice containing RTD beverage are similar to those obtained in a juice-containing beverage, and the inventive composition (combination of lauric arginate, sorbate, benzoate and EDTA) passed the comprehensive microbial challenge study.

Example 3: A nutrient fortified spring water. A nutrient fortified spring water beverage was purchased from a local grocery store. This beverage contained essential vitamins and minerals for health benefits along with 0% fruit juices, 0% calories and no sugar. This beverage had a pH of 3.1. The main ingredients in this beverage included spring water, natural flavors, citric acid, malic acid, sucralose (sweetener) and healthy nutrients such as vitamin C, vitamin E, niacin, vitamin B6, vitamin B12, biotin, pantothenic acid, magnesium, zinc and selenium. This product represents a group of zero-calories, sugar-free, nutrients-fortified flavored spring water beverages. The original beverage was used as control, while samples with added antimicrobials in a number of combinations were used as treatments. The spoilage microorganisms used in the challenge study include yeast and mold cocktails and Gluconoacetobacter species. The results of microbial challenge study are summarized in Table 4.

TABLE 4
Microbial challenge study for a nutrient fortified spring water beverage

| | Lauric | | | | | |
|---|---|---|---|---|---|---|
| Treatment | Arginate | K-sorbate | Na-benzoate | EDTA | Natamycin | Result |
| Test 1 | 0 | 175 ppm | 175 ppm | 0 | 0 | Fail (<7 days) |
| Test 2 | 30 ppm | 175 ppm | 175 ppm | 0 | 0 | Fail (<33 days) |
| Test 3 | 0 | 175 ppm | 175 ppm | 30 ppm | 0 | Fail (<7 days) |
| Test 4 | 0 | 175 ppm | 175 ppm | 0 | 10 ppm | Fail (<33 days) |
| Inventive | 30 ppm | 175 ppm | 175 ppm | 30 ppm | 0 | Pass (>4 months) |

Again, in this example, the inventive composition (combination of lauric arginate, sorbate, benzoate and EDTA) is the only antimicrobial system that passed the comprehensive microbial challenge study in a nutrient fortified spring water beverage.

Example 4: Cold-filled juice-containing RTD beverage. A base formula for an artificially flavored juice-containing RTD beverage was used in this example. This RTD beverage contained 10% apple juice, vitamin C, natural and artificial flavors, citric acid, sucrose and acesulfame potassium as sweeteners, and blue 1 as colorant. The pH of this beverage was 3.3. Three different antimicrobial ingredient combinations were formulated into the base formula. Each formulation was either processed without any heating and filled at 70° F., known as “cold process, cold fill” (labeled as “cold/cold” in Table 5) or pasteurized at 243° F. for 3 seconds and then cooled down to 70° F. and filled, known as “hot process, cold fill” (labeled as “hot/cold” in Table 5). The details of each antimicrobial formula and process conditions are listed in Table 5.

Table 5. Antimicrobial formulas and process conditions for an artifically flavoured juice drink and their microbial stability

TABLE 5
Antimicrobial formulas and process conditions for an artificially flavored juice
drink and their microbial stability

| | | | | | Process/ | |
|---|---|---|---|---|---|---|
| Production | Lauric | | Na- | | Fill | |
| batch | Arginate | K-Sorbate | Benzoate | EDTA | Condition | Result |
| A | 0 ppm | 300 ppm | 300 ppm | 30 ppm | Cold/Cold | Fail (<1 month) |
| B | 0 ppm | 300 ppm | 300 ppm | 30 ppm | Hot/Cold | Fail (<1 month) |
| C | 30 ppm | 300 ppm | 300 ppm | 30 ppm | Cold/Cold | Pass (>4 months) |
| D | 30 ppm | 300 ppm | 300 ppm | 30 ppm | Hot/Cold | Pass (>4 months) |
| E | 30 ppm | 450 ppm | 150 ppm | 30 ppm | Cold/Cold | Pass (>4 months) |
| F | 30 ppm | 450 ppm | 150 ppm | 30 ppm | Hot/Cold | Pass (>4 months) |

All beverage samples were inoculated with common spoilage bacterial, yeast and mold cocktails as described in Table 1. The samples were stored at an ambient temperature for microbial growth test. The results of microbial challenge study are summarized in Table 5.

Following storage for four weeks at ambient temperature, samples A and B (without lauric arginate) failed due to yeast growth and fermentation.

The samples containing variations of the antimicrobial compositions of the present invention (combinations of lauric arginate, sorbate, benzoate and EDTA) in batches C, D, E and F failed to show any substantial presence of bacteria, yeast and mold after 12 weeks of storage. Accordingly, these samples passed the comprehensive microbial challenge study.

These results suggest that the antimicrobial compositions of the present invention are sufficiently effective to allow the elimination of heat processing during beverage production thereby allowing cold process and cold fill. Heretofore, this type of processing has not been successful. The substitution of the widely employed hot process/hot fill processing with cold process/cold fill processing in the RTD beverage industry will provide dramatic quality and economic benefits.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An antimicrobial composition for use in a food product, the composition comprising:
a chelating agent;
a lauric acid derivative; and
at least two carboxylic acid derivatives,
wherein the chelating agent, the lauric acid derivative, and the at least two carboxylic acid derivatives are present in the antimicrobial composition in amounts effective, when incorporated into the food product, to achieve microbiological stability and maintain organoleptic properties of the food product during the shelf life of the food product.

2. The antimicrobial composition of claim 1, wherein the chelating agent is ethylenediaminetetraacetic acid or a derivative thereof; wherein the at least two carboxylic acid derivatives include a sorbate and a benzoate; and wherein the food product is a ready-to-drink beverage.

3. The antimicrobial composition of claim 1, wherein the lauric acid derivative is ethyl-N-dodecanoyl-L-arginate or a derivative thereof.

4. The antimicrobial composition of claim 2, wherein the lauric acid derivative is ethyl-N-dodecanoyl-L-arginate; and wherein the food product is cold processed.

5. The antimicrobial composition of claim 2, wherein the chelating agent is present at a level of about 10 to about 100 ppm; wherein the lauric acid derivative is present at a level of about 20 to about 100 ppm; and wherein the at least two carboxylic acid derivatives are independently present at a level of about 100 to about 1000 ppm, wherein all levels are based on the weight of the food product.

6. The antimicrobial composition of claim 3, wherein the chelating agent is present at a level of about 10 to about 100 ppm; wherein the lauric acid derivative is present at a level of about 20 to about 100 ppm; and wherein the at least two carboxylic acid derivatives are independently present at a level of about 100 to about 1000 ppm, wherein all levels are based on the weight of the food product.

7. The antimicrobial composition of claim 4, wherein the chelating agent is present at a level of about 10 to about 100 ppm; wherein the lauric acid derivative is present at a level of about 20 to about 100 ppm; and wherein the at least two carboxylic acid derivatives are independently present at a level of about 100 to about 1000 ppm, wherein all levels are based on the weight of the food product.

8. The antimicrobial composition of claim 5, wherein the level of the chelating agent is about 25 to about 35 ppm; wherein the level of the lauric acid derivative is about 20 to about 40 ppm; and wherein the two at least carboxylic acid derivatives are independently at levels of about 150 to about 500 ppm.

9. The antimicrobial composition of claim 6, wherein the level of the chelating agent is about 25 to about 35 ppm; wherein the level of the lauric acid derivative is about 20 to about 40 ppm; and wherein the two at least carboxylic acid derivatives are independently at levels of about 150 to about 500 ppm.

10. The antimicrobial composition of claim 7, wherein the level of the chelating agent is about 25 to about 35 ppm; wherein the level of the lauric acid derivative is about 20 to about 40 ppm; and wherein the two at least carboxylic acid derivatives are independently at levels of about 150 to about 500 ppm.

11. The antimicrobial composition of claim 8, wherein the shelf life of the food product is at least 4 months under ambient storage conditions.

12. The antimicrobial composition of claim 9, wherein the shelf life of the food product is at least 4 months under ambient storage conditions.

13. The antimicrobial composition of claim 10, wherein the shelf life of the food product is at least 4 months under ambient storage conditions.

14. An antimicrobial composition for use in a cold processed ready-to-drink beverage, said antimicrobial composition comprising:
a chelating agent present at a level of about 10 to about 100 ppm;
a lauric acid derivative present at a level of about 20 to about 100 ppm;
a sorbate present at a level of about 100 to about 1000 ppm; and
a benzoate present at a level of about 100 to about 1000 ppm,
wherein the levels of the chelating agent, the lauric acid derivative, the sorbate, and the benzoate are (1) based on the weight of the cold processed ready-to-drink beverage and (2) are effective, when incorporated into the cold processed ready-to-drink beverage, to achieve microbiological stability and maintain organoleptic properties of the cold processed ready-to-drink beverage during the cold processed ready-to-drink beverage's shelf life.

15. The antimicrobial composition of claim 14, wherein the chelating agent is ethylenediaminetetraacetic acid or a derivative thereof; wherein the lauric acid derivative is ethyl-N-dodecanoyl-L-arginate or a derivative thereof; wherein the sorbate is potassium sorbate or sodium sorbate; and wherein the benzoate is potassium benzoate or sodium benzoate.

16. The antimicrobial composition of claim 14, wherein the chelating agent is at about 25 to about 35 ppm; wherein the lauric acid derivative is at a level of about 20 to about 40 ppm; wherein the sorbate is at a level of about 150 to about 500 ppm; wherein the benzoate is at a level of about 150 to about 500 ppm; and wherein the shelf life of the cold processed ready-to-drink beverage is at least about 4 months under ambient conditions.

17. The antimicrobial composition of claims 15, wherein the chelating agent is at about 25 to about 35 ppm; wherein the lauric acid derivative is at a level of about 20 to about 40 ppm; wherein the sorbate is at a level of about 150 to about 500 ppm; wherein the benzoate is at a level of about 150 to about 500 ppm; and wherein the shelf life of the cold processed ready-to-drink beverage is at least about 4 months under ambient conditions.

18. A cold processed ready-to-drink beverage having a shelf life of at least about 4 months at ambient temperatures, said cold processed ready-to-drink beverage containing an antimicrobial composition comprising:
a chelating agent present at a level of about 10 to about 100 ppm;
a lauric acid derivative present at a level of about 20 to about 100 ppm;
a sorbate present at a level of about 100 to about 1000 ppm; and
a benzoate present at a level of about 100 to about 1000 ppm,
wherein the levels of the chelating agent, the lauric acid derivative, the sorbate, and the benzoate are (1) based on the weight of the cold processed ready-to-drink beverage and (2) are effective to achieve microbiological stability and maintain organoleptic properties of the cold processed ready-to-drink beverage during the at least about 4 month shelf life at ambient temperatures.

19. The cold processed ready-to-drink beverage of claim 18, wherein the chelating agent is ethylenediaminetetraacetic acid or a derivative thereof; wherein the lauric acid derivative is ethyl-N-dodecanoyl-L-arginate or a derivative thereof; wherein the sorbate is potassium sorbate or sodium sorbate; and wherein the benzoate is potassium benzoate or sodium benzoate.

20. A method for producing a cold processed ready-to-drink beverage having a shelf life of at least about 4 months at ambient temperatures, said method comprising
(1) providing a ready-to-drink beverage prepared using cold processing conditions;
(2) adding an antimicrobial composition to the ready-to-drink beverage either before, during, or after its preparation using cold processing conditions; and
(3) packaging and sealing the ready-to-drink beverage containing the antimicrobial composition in a container,
wherein the antimicrobial composition comprises
a chelating agent present at a level of about 10 to about 100 ppm;
a lauric acid derivative present at a level of about 20 to about 100 ppm;
a sorbate present at a level of about 100 to about 1000 ppm; and
a benzoate present at a level of about 100 to about 1000 ppm,
wherein the levels of the chelating agent, the lauric acid derivative, the sorbate, and the benzoate are (1) based on the weight of the cold processed ready-to-drink beverage and (2) are effective to achieve microbiological stability and maintain organoleptic properties of the cold processed ready-to-drink beverage during the at least about 4 month shelf life at ambient temperatures.

21. The method of claim 20, wherein the wherein the chelating agent is ethylenediaminetetraacetic acid or a derivative thereof; wherein the lauric acid derivative is ethyl-N-dodecanoyl-L-arginate or a derivative thereof; wherein the sorbate is potassium sorbate or sodium sorbate; and wherein the benzoate is potassium benzoate or sodium benzoate.

22. The method of claim 20, wherein the cold processing conditions include cold processing and cold filling.

23. The method of claim 21, wherein the cold processing conditions include cold processing and cold filling.
